(19) United States
(12) Patent Application Publication
(10) Pub. No.: US 2004/0006532 A1
(43) Pub. Date: Jan. 8, 2004

(54) Network access risk management

(76) Inventors: David Lawrence, New York, NY (US); Carl Young, New York, NY (US)

Correspondence Address: Clifford Chance US LLP, 200 Park Avenue, New York, NY, 10166, US

(21) Appl. No.: 10/385,557

(22) Filed: Mar. 11, 2003

Related U.S. Application Data
(63) Continuation-in-part of application No. 10/074,584, filed on Feb. 12, 2002.
Application No. 10/074,584 is a continuation-in-part of application No. 10/021,124, filed on Oct. 30, 2001.
Application No. 10/021,124 is a continuation-in-part of application No. 09/812,627, filed on Mar. 20, 2001.
(60) Provisional application No. 60/363,184, filed on Mar. 11, 2002.

(51) Int. Cl. G06F 17/60

(52) U.S. Cl. 705/38

(57) ABSTRACT

A computerized method and system for managing risk associated with allowing access to a network resource is disclosed. Information relating to network access is gathered and stored as data in preparation for a risk inquiry search relating to a network access. Documents and sources of information can also be stored. A subscriber, such as a Financial Institution, can submit information descriptive of an access to a network resource to a risk management system. The system can perform a risk inquiry according to the information. The risk assessment or inquiry search can include data retrieved resultant to augmented retrieval methods. Scrubbed data as well as augmented data can be transmitted from a risk management clearinghouse to a subscriber. A risk quotient can be calculated based upon information related to a network access and remedial action can be taken based upon the risk quotient.

### CROSS REFERENCE TO RELATED APPLICATIONS

This application claims priority to U.S. patent application Ser. No. 60/363,184 filed Mar. 11, 2002 and entitled “Network Access Risk Management”. This application is a continuation-in-part of a prior application entitled “Risk Management Clearinghouse” filed Feb. 12, 2002, and bearing the Ser. No. 10/074,584, which is also a continuation-in-part of a prior application entitled “Risk Management Clearinghouse” filed Oct. 30, 2001 and bearing the Ser. No. 10/021,124, which is also a continuation-in-part of a prior application entitled “Automated Global Risk Management” filed Mar. 20, 2001, and bearing the Ser. No. 09/812,627, both of which are relied upon and incorporated by reference.

### BACKGROUND

This invention relates generally to a method and system for facilitating the identification, investigation, assessment and management of legal, regulatory, financial and reputational risks (“Risks”). In particular, the present invention relates to a computerized system and method to assess risk associated with making a resource available via a computerized network, such as the Internet.

It may be important for a resource sponsoring institution to monitor access to an online resource. In particular it may be important for the institution to ascertain who is utilizing an online resource as well as monitor any attempts to gain unauthorized access to a network resource controlled by the institution. A financial institution may have an increased interest in monitoring such activity due to important public policy concerns related to protection of proprietary data and sensitivity to money-laundering. Regulators have attempted to address money laundering and terrorist issues by imposing formal and informal obligations upon financial institutions. Government regulations authorize a broad regime of record-keeping and regulatory reporting obligations on covered financial institutions as a tool for the federal government to use to fight drug trafficking, money laundering, and other crimes.

Obligations include those imposed by the Department of the Treasury and the federal banking regulators which adopted suspicious activity report (“SAR”) regulations. These SAR regulations require that financial institutions file SARs whenever an institution detects a known or suspected violation of federal law, or a suspicious transaction related to a money laundering activity. The regulations can impose a variety of reporting obligations on financial institutions. Federal regulators have made clear that the practical effect of these requirements is that financial institutions need to engage in adequate monitoring of transactions. Accordingly, it would be useful to ascertain who is accessing a financial institution's network resources, a pattern of access and any identifying information that may relate the access to known high risk entities.

Bank and non-bank financial institutions, including: investment banks; merchant banks; commercial banks; securities firms, including broker dealers securities and commodities trading firms; asset management companies, network access, mutual funds, credit rating funds, securities exchanges and bourses, institutional and individual investors, law firms, accounting firms, auditing firms, any institution the business of which is engaging in financial activities as described in section 4(k) of the Bank Holding Act of 1956, and other entities subject to legal and regulatory compliance obligations with respect to money laundering, fraud, corruption, terrorism, organized crime, regulatory and suspicious activity reporting, sanctions, embargoes and other regulatory risks and associated obligations, hereinafter collectively referred to as “Financial Institutions,” typically have few resources available to them to assist in the identification of present or potential risks associated with business transactions.

Risk can be multifaceted and far reaching. Generally, personnel do not have available a mechanism to provide real time assistance to assess a risk factor or otherwise qualitatively manage risk. In the event of problems, it is often difficult to quantify to regulatory bodies, shareholders, newspapers and other interested parties, the diligence exercised by the Financial Institution to properly identify and respond to risk factors. Absent a means to quantify good business practices and diligent efforts to contain risk, a Financial Institution may appear to be negligent in some respect.

Financial Institutions do not have available a mechanism which can provide real time assistance to assess a risk factor associated with a network access, or otherwise qualitatively manage such risk. In the event of network violations, it is often difficult to quantify to regulatory bodies, shareholders, newspapers and/or other interested parties, the diligence exercised by the Financial Institution to properly identify and respond to network related risk factors. Absent a means to quantify good business practices and diligent efforts to contain risk, a Financial Institution may appear to be negligent in some respect.

What is needed is a method and system to ascertain an identity associated with a network access and relate the identity to information useful in assessing risk. A new method and system should anticipate offering guidance to personnel who interact with clients and help the personnel identify high risk situations. In addition, it should be situated to convey risk information to a compliance department and be able to demonstrate to regulators that a Financial Institution has met standards relating to risk containment.

### SUMMARY

Accordingly, the present invention provides methods and systems for managing risk associated with access to a resource made available via a network, such as the Internet.

A risk management clearinghouse can gather data relevant to risk that can be associated with making a resource accessible on a network. Data can be gathered from multiple sources and be relevant to risk associated with making the resource available on a network. An inquiry can be received relating to a network address of the resource. Portions of the gathered data can be associated with the network access and the associated portions of the aggregated data can be transmitted to a subscriber making the inquiry.

If desired, the gathered data can be gathered exclusively from publicly available sources. The transmitted portion of gathered data can include a name of an entity associated with the network address or a geographic location associated with the network address. The transmitted portions of gathered data can include an association of the name with a government list comprising high risk variables, such as an adverse political association or the name of a terrorist related entity. Other gathered data can include the name of an entity associated with fraud.

A pattern of access associated with an unauthorized use of the resource available on the network can also be recorded. If desired, pattern of access can be included in the gathered data. The gathered data can also include a pattern of access to the resource available via the communications network by multiple network addresses associated with a particular name.

Transmitting the associated portions of the aggregated data can be conditioned upon receipt of a contractual obligation to limit use of the aggregated data for complying with regulatory and legal obligations associated with at least one of. (i) the detection and prevention of money laundering, (ii) fraud, (iii) corrupt practices, (iv) organized crime, and (v) activities subject to government sanctions or embargoes or a contractual obligation to limit use of the aggregated data for at least one of: (i) the prevention or detection of a crime, (ii) the apprehension or prosecution of offenders, and (iii) the assessment or collection of a tax or duty.

From a user's perspective, a network address of a communication device accessing the resource can be recorded and transmitted to a risk management clearinghouse such that data related to risk variables associated with the network address can be received.

Other embodiments of the present invention can include a computerized system, executable software, or a data signal implementing the inventive methods of the present invention. The computer server can be accessed via a network access device, such as a computer. Similarly, the data signal can be operative with a computing device, and computer code can be embodied on a computer readable medium.

In another aspect, the present invention can include a method and system for a user to interact with a network access device so as to manage risk relating to a risk subject. The user can initiate interaction with a proprietary risk management server via a communications network and input information relating to details of the risk subject, such as, for example, via a graphical user interface, and receive back a information related to the risk subject.

Various features and embodiments are further described in the following figures, drawings and claims.

### DESCRIPTION OF THE DRAWINGS

FIG. 1 illustrates a block diagram that can embody this invention.

FIG. 2 illustrates a network of computer systems that can embody an automated Network access 105 risk management system.

FIG. 3 illustrates a flow of exemplary steps that can be executed by a system implementing the present invention.

FIG. 4 illustrates a flow of exemplary steps that can be executed by a system to

FIG. 5 illustrates a flow of exemplary steps that can be taken by a user of the Network Access risk management system.

### DETAILED DESCRIPTION

The present invention includes a computerized method and system for managing risk associated with making a resource available on a publicly accessible network, such as the Internet. A computerized system, such as a Risk Management Clearinghouse (RMC) gathers and stores information which can be useful to asses risk as data in a database, or other data storing structure, and processes the data in preparation for a risk inquiry search relating to a network access 105. An inquiry may be related, for example, to a network address assigned to a network access device that is being utilized to access the network resource. Reference documents and sources of information can also be stored and retrieved via the inquiry. A subscriber, such as a financial institution, can submit data descriptive of a network access 105 for which a risk inquiry search can be performed. A risk assessment or inquiry search is performed relating to the network address. The inquiry search can include data retrieved resultant to augmented retrieval methods. Scrubbed data as well as augmented data can be transmitted from a RMC, or a proprietary risk management (PRM) system maintained in-house, to a subscriber. Risk inquiry searches can be automated and made a part of standard operating procedure for any transaction conducted by the subscriber in which a network access 105 is involved.

Risk associated with making a resource available on a publicly available network, such as an Internet website, can include factors associated with financial risk, legal risk, regulatory risk and reputational risk. Financial risk includes factors indicative of monetary costs that the Financial Institution may be exposed to as a result of performing a particular transaction. Monetary costs can be related to fines, forfeitures, costs to defend an adverse position, lost revenue, or other related potential sources of expense. Legal risk relates to liabilities that a Financial Institution may face as a result to making a resource available. Regulatory risk includes factors that may cause the Financial Institution to be in violation of rules put forth by a regulatory agency such as the Securities and Exchange Commission (SEC). Reputational risk relates to harm that a Financial Institution may suffer regarding its professional standing in the industry. A Financial Institution can suffer from being associated with a situation that may be interpreted as contrary to an image of honesty and forthrightness. Such risks can also befall other entities, such as for example, without limitation, in situations known as “white goods” money laundering.

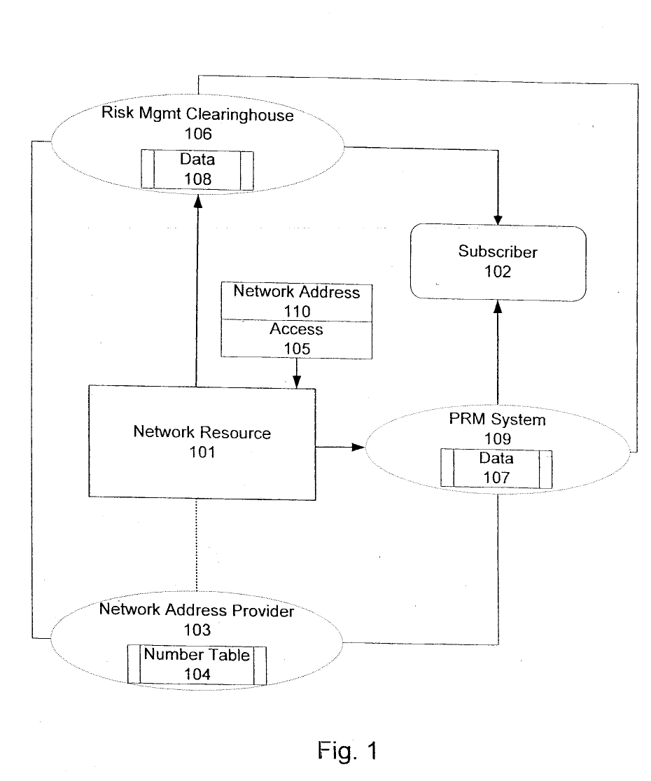

Referring now to FIG. 1 a block diagram of some embodiments of the present invention is illustrated. An RMC system 106, or Proprietary Risk Management (PRM) system 109, gathers and receives information which is related to risk variables. According to the present invention, the risk variables are analyzed to ascertain if they can be associated with a network address 110, such as, for example through a nexus to the entity to which the address is registered.

A subscriber 102 can make a network resource 101 available via a network. In some instances, the network will available to the public. In other instances, a private network will be utilized. A network address 110 can be associated with an access 105 made to the network resource 101. The network address can be forwarded to a risk management system, such as an RMC 106 and/or a PRM system 109. The risk management system 106 109 can associate the network address 110 to data 107-108 related to risk variables and forward the risk variable related data 107-108 to the subscriber. If desired, the risk variable related data can include copies of reference documents and/or a source of specific information.

A network address provider 103, such as the Internet Corporation for Assigned Names and Numbers (InterNic), can provide information associating a network address with a name and if available a geographic location associated with the name. The network address provider 103 may also maintain an address table 104 or number table that relates a network address to a name. If available, the entire table can be received into a risk management system 106 109. In different embodiments, the network access 105 provider 103 can provide information directly to a network resource 101, a PRM system 107, or a RMC system 106.

Information gathered into the RMC system 106 or PRM system 109 may also be received from publicly available or private sources, including, for example: the Office of Foreign Access Control (OFAC), the U.S. Commerce Department List, the U.S. White House List, a Foreign Counterpart list, a List of U.S. Federal Regulatory Actions, EDGAR, the SEC, Commodities Futures Trading Corp. (CTFC), North American Securities Administrators Association (NASAA), National White Collar Crime Center (NW3C), a state or federal attorney general's office, a subscriber, investigation entity, or other source, such as a foreign government, U.S. adverse business-related media reports, U.S. state regulatory enforcement actions, international regulatory enforcement actions, international adverse business-related media reports, a list of politically connected individuals and military leaders, list of U.S. and international organized crime members and affiliates, a list put forth by the Financial Action Task Force (FATF), a list of recognized high risk countries, or other source of high risk variables. Court records or other references relating to fraud, bankruptcy, professional reprimand or a rescission of a right to practice, suspension from professional ranks, disbarment, prison records or other source of suspect behavior can also be an important source of information.

Typically, a network on which a resource will be made available will be based upon some proprietary convention for transmitting data between two or more machines within the same network. Each machine will have a unique network address which identifies the machine. For example, on a LAN, data will typically be sent between machines according to a six byte unique identifier (“MAC” address), an SNA network utilizes Logical Units each with a unique network address, Appletalk and Novell assign numbers to each local network and to each workstation attached to the network. Inter-network communication, such as the Internet, requires a common protocol that can be supported by each proprietary convention.

One common protocol widely utilized for basic services on a computerized network to provide functionality such as file transfer, electronic mail, website access, instant messaging is TCP/IP (Transfer Control Protocol/Internet Protocol). TCP/IP can provide interoperability across a multiple server systems and network access devices, such as a personal computer accessing the Internet. TCP/IP also provides for a unique network address to be associated with each device accessing the network.

With TCP/IP, each computer accessing the Internet has a unique address called an Internet Protocol address (IP address). An IP address can be associated with a Domain Name System (DNS) wherein the name typically has a meaning to facilitate locating the resource on the Internet. The DNS makes using the Internet easier by allowing a mnemonic device, such as familiar string of letters (the “domain name”) to be used to designate a resource instead of an arcane IP address.

IP is responsible for moving a packet of data from one node on a network to another node on the network. Typically, IP will forward a packet based on an IP number that includes a four byte destination address. An Internet regulating authority can assign a range of IP numbers to an organization. In turn, an organization can assign a group of numbers to a subgroup, such as a department or other user group. IP will typically operate on a computer situated to move data from one level to the next, such as from a department to an organization, or from an organization to a region, or from a region to global access.

Transfer Control Protocol (TCP) can provide functionality for verifying a correct delivery of data from a client to a destination, such as server. In order to address the possibility of data being lost during transmission, TCP adds support to detect errors or lost data and to trigger retransmission until the data is correctly and completely received.

Generally a network access device, further discussed below, will employ subroutines, such as a socket subroutine to provide access to TCP/IP on most network systems. TCP/IP will assign a unique number to each network access device on top of a local or vendor specific network address. In this manner, each network access 105 is uniquely identifiable via such a TCP/IP address. By convention, an IP number is a four byte value that is expressed by converting each byte into a decimal number (0 to 255) and separating the bytes with a period. An address is represented by character string that can be represented by ###.###.##.# or 255.255.255.0, since 255 is the largest byte value and represents the number with all bits turned on.

A local network can connect to the Internet through a regional or specialized network supplier. The network supplier adds a subscriber network address to a routing configuration in the network supplier's computers and can also transmit the subscriber network information to other network suppliers in order to keep all routing configurations current.

Computers utilized to run large regional networks or the central Internet routers managed by the National Science Foundation maintain tables that correlate a name with a network address or number.

Information relating to names correlating to TCP/IP addresses can be gathered into a RMC system 106 and/or a PRM system 109. In addition risk variable information can also be gathered and updated in the RMC system 106 or a PRM system 109. The RMC 106 and/or PRM 109 can relate risk variable information contained in the gathered data to an entity to which a network address is registered.

In some embodiments, an alert list can be generated by comparing all known entities to whom a network address has been issued, or who can otherwise be related to a network address, with risk variables, such as those available via a RMC system 106 or PRM system 109. A list of network addresses deemed to be associated with an increased risk can be made available to a network administrator or other appropriate person for the purposes of modifying access rights to an online resource according to a level of risk associated with a particular network address. In addition, a network address with a marginally elevated level of risk can be exposed to an increased level of monitoring during any access to a network resource.

An RMC system 106 or PRM system 109 can facilitate meeting due diligence requirements on the part of a subscriber 102 by gathering, structuring and providing to the subscriber 102 data that relates risk variables with a network access 105.

A risk variable can include any datum associated with a specified network access 105 that may cause a level of risk relating to the specified network access 105 to change. An RMC system 106 can compare and relate received information associated with a network access 105 with information descriptive of risk subjects, such as information available from government sources and the like which identifies high risk individuals, entities or organizations. If an association is made between a network access 105 and a high risk subject the RMC 106 or PRM 109 can forward related information to the subscriber 102. The related information can contain the association made, as well as supporting details. For example, a Financial Institution may request information on a network access 105 that has requested that the Financial Institution execute a particular transaction. The Financial Institution may submit an inquiry requesting information related to risk variables, such as, who is associated with a network access 105, a geographic or political location associated with the network address, or other related information. In addition, the Financial Institution may need to know if any of the parties or jurisdictions associated with the network access 105 is included on any list issued by the government relating to high risk activity.

A subscriber 102 can include, for example: a securities broker, a retail bank, a commercial bank, an investment and merchant bank, a private equity firm, an asset management company, a mutual fund company, an insurance company, a credit card issuer, a retail or commercial financier, a securities exchange, a regulator, a money transfer agency, a bourse, an institutional or individual investor, an auditing firm, a law firm, any institution the business of which is engaging in financial activities as described in section 4(k) of the Bank Holding Act of 1956 or other entity, institution, or Financial Institution who may be involved with providing resources on a publicly accessible network, such as the Internet, or a private network.

A subscriber 102 can also input information relating to a network access 105 into a PRM system 109, or a RMC 106 if it is permissible to share the information under prevailing law. Subscriber supplied information can include information gathered according to normal course of dealings with a network resource or discovered via investigation, including a history of suspicious activity associated with a network address, a pattern of access, frequency of access, types of activities entered into during the access, or other information that can be related to a network address. In addition, in accordance with prevailing law, a Financial Institution may discover or suspect that a person or entity related to a network access 105 is involved in some fraudulent or otherwise illegal activity and report this information to the RMC system 106 and/or a PRM system 109, as well as an appropriate authority.

A decision by a Financial Institution concerning whether to pursue a transaction involving a network address can be dependent upon multiple risk variables. A multitude and diversity of risks related to the variables may need to be identified and evaluated. In addition, the weight and commercial implications of each variable and associated risks can be interrelated.

Information gathered from the diversity of data sources can be aggregated into a searchable data storage structure 107-108. A source of information can also be received and stored. In some instances a subscriber 102 may wish to receive information regarding the source of information received. Gathering data into an aggregate data structure 107-108, such as a data warehouse allows a RMC system 106 and/or a PRM system 109 to have the data 107-108 readily available for processing a risk management search associated with a network address. Aggregated data 107-108 can also be scrubbed or otherwise enhanced.

In some embodiments of enhancing data, data scrubbing can be utilized to implement a data warehouse comprising the aggregate data structure 107-108. Data scrubbing can take information from multiple databases and store it in a manner that gives faster, easier and more flexible access to key facts. Scrubbing can facilitate expedient access to accurate data commensurate with the critical business decisions that will be based upon the risk management assessment provided.

Various data scrubbing routines can be utilized to facilitate aggregation of risk variable related information. The routines can include programs capable of correcting a specific type of mistake, such as an incomprehensible address, or clean up a full spectrum of commonly found database flaws, such as field alignment that can pick up misplaced data and move it to a correct field or removing inconsistencies and inaccuracies from like data. Other scrubbing routines can be directed directly towards specific legal issues, such as money laundering or terrorist tracking activities.

For example, a scrubbing routine can be used to facilitate various different spelling of one name. In particular, spelling of names can be important when names have been translated from a foreign language into English. An illustration of this example can include a languages or alphabet, such as Arabic, which has no vowels. Translations from Arabic to English can be very important for Financial Institutions seeking to be in compliance with lists supplied by the U.S. government that relate to terrorist activity and/or money laundering. A data scrubbing routine can facilitate risk variable searching for multiple spellings of an equivalent name or other important information. Such a routine can enhance the value of the aggregate data gathered and also help correct database flaws. Scrubbing routines may improve and expand data quality more efficiently than manual review and also allow a subscriber 102 to quantify best practices for regulatory purposes.

Retrieving information related to risk variables from the aggregated data 107-108 is an operation with the goal to fulfill a given a request. In order to process a request against a large document set of aggregated risk data with a response time acceptable to the user, it may be necessary to utilize an index based approach as opposed to a direct string comparison search which may be unsuitable.

An index file for a collection of documents can therefore be built upon receipt of the new data and prior to a query or other request. The index file can include a pointer to the document and also include important information contained in the documents the index points to. At query time, the RMC system 106 can match the query against a representation of the documents, instead of the documents themselves. The RMC system 106 can retrieve the documents referenced by the indexes that satisfy the request if the subscriber submits such a request. However it may not be necessary to retrieve the full document as index records may also contain the relevant information gleaned from the documents they point to. This allows the user to extract information of interest without having to read the source document.

At least two retrieval models can be utilized in fulfilling a search request. A first includes Boolean retrieval in which a document set is partitioned in two disjoint parts with one fulfilling a query and one not fulfilling it. A second includes relevance ranking in which all the documents are considered relevant to a certain degree. Boolean logic models use exact matching, while relevance ranking models use fuzzy logic, vector space techniques (all documents and the query are considered vectors in a multidimensional space, where the shorter the distance between a document vector and the query vector, the more relevant is the document), neural networks, and probabilistic schema. In a relevance ranking model, low ranked elements may not contain the query terms.

Augmenting data can include data mining techniques that use sophisticated software to analyze and sift through aggregated data 107-108 stored in the warehouse using techniques such as mathematical modeling, statistical analysis, pattern recognition, rule based trends or other data analysis tools. In contrast to traditional systems that may have gathered and stored information in a flat file and regurgitated the stored information when requested, such as in a defined report related to a specific risk subject or other ad hoc access concerned with a particular query at hand, the present invention can provide risk related searching that adds a discovery dimension by returning results that human operator would find very labor and cognitively intense.

This discovery dimension supplied by the RMC system 106 or the PRM system 109 can be accomplished through the application of augmenting techniques, such as data mining applied to the risk related data that has been aggregated. Data mining can include the extraction of implicit, previously unknown and potentially useful information from the aggregated data 107-108. This type of extraction can include unlooked for correlations, patterns or trends. Other techniques that can be applied can include fuzzy logic and/or inductive reasoning tools.

For example, augmenting routines can include enhancing available data with routines designed to reveal hidden data. Revealing hidden data or adding data fields derived from existing data can be very useful to risk management. For example, is supplied data may not include an address for a person involved in a network access 105; however a known telephone number is available. Augmented data can include associating the telephone number with a geographic area. The geographic area may be a political boundary, or coordinates, such as longitude and latitude coordinates, or global positioning coordinates. The geographic area identified can then be related to high risk or low risk areas.

An additional example of augmented data derived from a telephone number would include associating the given telephone number with a high risk entity, such as a person listed on an OFAC list.

In some embodiments, a subscriber 102 can access the RMC system 106 via a computerized system, as discussed more fully below. The subscriber can input a description of a network access 105, network address 110, or other inquiry, such as the name of a party associated with a network address 110. The RMC system 106 or PRM system 109 can receive the identifying information and perform a risk related inquiry or search on the aggregated data 107-108, including, if it is available, any scrubbed data.

In other embodiments, a subscriber 102 can house a computerized PRM system 109. The PRM system 109 can receive an electronic feed from an RMC system 106 with updated data, including, if it is available, any scrubbed data. In addition, data mining results can also be transmitted to the PRM system 109 or performed by the PRM system 109 for integration into the risk management practices provided in-house by the subscriber.

Information entered by a subscriber into a PRM system 109 may be information gathered according to normal course of dealings with a particular network address or as a result of a concerted investigation. In addition, since the PRM system 109 is proprietary and a subscriber responsible for the information contained therein can control access to the information contained therein, the PRM system 109 can include information that is public or proprietary. If desired, information entered into the PRM system 109 can be shared with a RMC system 106. Informational data can be shared, for example via an electronic transmission or transfer of electronic media. However, RMC system data 107-108 may be subject to applicable local or national law and safeguards should be adhered to in order to avoid violation of such law through data sharing practices. In the event that a subscriber, or other interested party, discovers or suspects that a person or entity is involved in a fraudulent or otherwise illegal activity, the system can report related information to an appropriate authority.

The RMC system 106 provides updated input into an in-house risk management database contained in a PRM system 109. The utilization of a RMC system 106 in conjunction with a PRM system 109 can allow a financial institution, or other subscriber, to screen the network access 105 related entities with various due diligence checks on an efficient basis.

A log or other stored history can be created by the RMC system 106 and/or a PRM system 109, such that utilization of the system can mitigate adverse effects relating to a problematic account. Mitigation can be accomplished by demonstrating to regulatory bodies, shareholders, news media and other interested parties that corporate governance is being addressed through tangible risk management processes.

An inquiry can also be automatically generated from ongoing monitoring of activity on a network resource, or taking place with systems under control of a subscriber 102. For example, an information system can electronically scan data involved in activity being conducted on a network resource, for key words, entity names, geographic locales, or other pertinent data relating to network access 105. Programmable software can be utilized to formulate an inquiry according to a network address, data input resultant to an access to a network resource, an entity associated with a network address or other pertinent data. The inquiry can be run against a database maintained by the RMC system 102 or in a PRM system 109. Other methods of generating an inquiry can include voice request via a telephone or other voice line, fax, electronic messaging, or other means of communication. An inquiry can also include direct input into a RMC system 106 or PRM system 109, such as through a graphical user interface (GUI) with input areas or prompts.

An inquiry can also be generated by filling in data in a GUI with fields or prompts. Prompts or other questions proffered by the RMC system 106 or PRM system 109 can be according to predetermined data fields, or depend from previous information received. Information generally received, or received in response to the questions, can be input into the RMC system 106 or PRM system 109 from which it can be utilized for real time risk assessment and generation of a risk valuation, such as a risk quotient.

An alert list containing names and/or terms related to a network access 105 can also be supplied to the RMC system 106 by a subscriber 102 or other source. Each alert list can be customized and specific to a subscriber 102. The RMC system 106 can continually monitor data in its database via an alert inquiry with key word, fuzzy logic or other search algorithms and transmit related informational data to the interested party. In this manner, ongoing diligence can be conducted. In the event that new information is uncovered by the alert inquiry, the subscriber 102 can be notified. Appropriate action can be taken according to the information uncovered.

The RMC system 106 can quantify risk due diligence by capturing and storing a record of information received and actions taken relating to a network access 105. Once quantified, the due diligence data can be utilized for presentation, as appropriate, to regulatory bodies, shareholders, news media and/or other interested parties, such presentation may be useful to mitigate adverse effects relating to a problematic transaction. The data can demonstrate that corporate governance is being addressed through tangible risk management processes.

In some embodiments, an risk management database 107-108 can contain only information collected from publicly-available sources relevant for the detection and prevention of money laundering, fraud, corrupt practices, organized crime, activities subject to governmental sanctions or embargoes, or other similar activities that are the subject of national and/or global regulation. A subscriber 102 can use the database to identify the possibility that a risk subject associated with a network access 105 may be involved in illegal activities.

A subscriber 102 to the RMC system 106 can access the database electronically and to receive relevant information electronically and, in specific circumstances, hard copy format. If requested, a RMC system 106 provider can alert a subscriber 102 upon its receipt of new RMC system 106 entries concerning a previously screened individual. A subscriber 102 will be permitted to access information in the RMC system 106 in various ways, including, for example: system to system inquires involving single or batch screening requests, individual inquiries (submitted electronically, by facsimile, or by phone) for smaller screening requests, or through a web-based interface supporting an individual look-up service. Generally, employees and vendors will not be permitted to use or share to information about subscriber requests or network access 1O5es unless such information involved is necessary to provide a requested product or service or to fulfill legal obligations under prevailing law.

In some embodiments, an RMC system 106 can take any necessary steps so as not to be regulated as a consumer reporting agency. Such steps may include not collecting or permitting others to use information from the RMC database 107-108 to establish an individual's eligibility for consumer credit or insurance, other business transactions, or for employment or other Fair Credit Reporting Act (FCRA) covered purposes such as eligibility for a government benefit or license.

To satisfy the requirements of this embodiment, a subscription agreement can be established between the RMC system 106 provider and a subscriber which will create enforceable contractual provisions prohibiting the use of data from the RMC database 108 for such purposes. The operations of the RMC system 106 can be structured to minimize the risk that the RMC database 108 will be used to furnish consumer reports and therefore become subject to the FCRA. Additional policies and practices can also be established to achieve this objective, such as, for example: the information in the RMC database 1O8can be collected only from reputable, publicly available sources and not contain information from consumer reports; the RMC system 106 can collect and permit others to use the information only for the purpose of complying with regulatory and legal obligations associated with the detection and prevention of money laundering, fraud, corrupt practices, organized crime, activities subject to governmental sanctions or embargoes, or other illegal activities that are the subject of national and/or global regulation. A subscriber 102 can be required to execute a licensing agreement that will limit the subscriber's use of the data to specified purposes, including specifically that the subscriber will not use the information to determine a consumer's eligibility for any credit, insurance, other business transaction or for employment or other FCRA-covered purposes each subscriber can be required to certify that the subscriber will use the data 108 only for such specified purposes, and to certify annually that the subscriber remains in compliance with these principles.

A licensing agreement can also require that a subscriber 102 separately secure information from non-RMC system 106 sources to satisfy any need the subscriber has for information to be used in connection with the subscriber's determination regarding a consumer's eligibility for credit, insurance, other business transactions, or employment or for other FCRA-covered purposes.

In another embodiment, an RMC system 106 may allow dissemination of database information for purposes including: the prevention or detection of crime; the apprehension or prosecution of offenders; or the assessment or collection of any tax or duty.

In still another aspect, an RMC system 106 can be structured to take advantage of the immunity from liability for libel and slander granted by the Communications Decency Act (“CDA”) to providers of interactive computer services. Where its operations are not protected by the CDA, an RMC system 106 may be able to reduce its risk of liability for defamation substantially by relying only on official sources and other reputable sources, and taking particular care with defamatory information from unofficial sources. hi addition the RMC system 106 provider can take reasonable steps to assure itself of the information's accuracy, including insuring that the source of the information is reputable.

The RMC system 106 can operate an interactive computer service as that term is defined in the CDA. The clearinghouse can therefore provide an information service and/or access software that enables computer access by multiple users to a computer server. In some embodiments, if desired, an RMC system 106 provider can limit its employees or agents from creating or developing any of the content in the RMC database 107-108. Content be maintained unchanged except that the RMC system 106 can remove information from the database that it determines to be inaccurate or irrelevant.

Still other embodiments can incorporate a transmission of information from the RMC database 107-108 that will be carefully structured such that the RMC system 106 will not provide “consumer reports” regulated by the FCRA. As such, the data may be limited by not relating to consumers, but rather to corporate entities. Data on consumers can be prevented from identifying them definitively, inasmuch as the individual named in a public record may or may not be the individual who is the subject of a RMC search. Moreover, the RMC system 106 can forego collecting information in order to provide consumer reports, and also not use or have a reasonable basis to expect that subscribers will use, any RMC data 107-108 for FCRA covered purposes.

As an example of such an embodiment, the RMC system 106 can limit collection of data to that information that will be relevant for the detection and prevention of money laundering, fraud, corrupt practices, organized crime, activities subject to governmental sanctions or embargoes, or other similar activity that is the subject of national and/or global regulation. The RMC system 106 and PRM system 109 can be limited to collecting information for the database 107-108 solely from publicly-available sources, principally information from news media and information released to the public by government agencies, such as regulatory enforcement action notice and embargo, sanction and criminal-wanted lists.

If desired, in order to help avoid implications with the Fair Credit Reporting Act (FCRA), an embodiment can prevent data from including identifiers that would assure the subscriber that the subject of the data is the same person as the subject of the subscriber's inquiry. For example, while the data will typically identify the subject by name, they often will not include a social security number, photograph, postal address, or similar comparatively definitive identification. As many people share identical names, a subscriber often will be unsure whether any or all of the data received relate to the person inquired about.

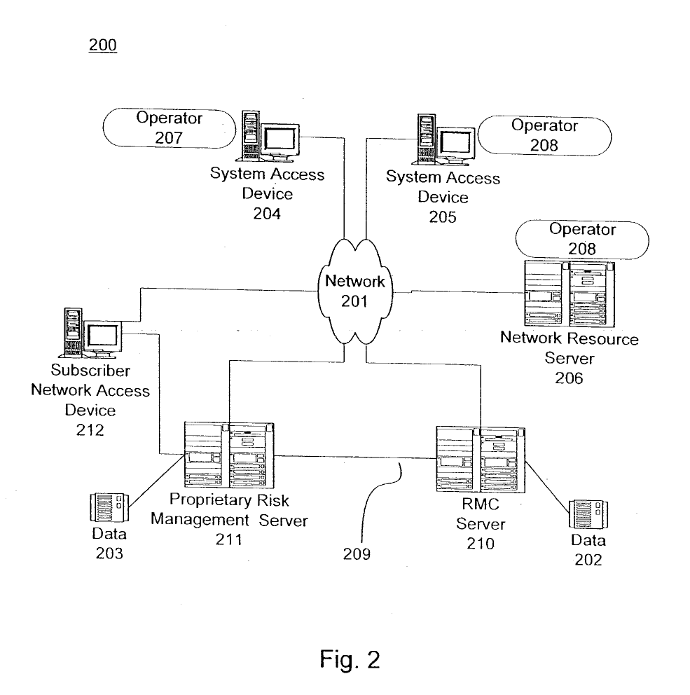

Referring now to FIG. 2, a network diagram illustrating some embodiments of the present invention is shown 200. An automated RMC 106 can include a computerized RMC server 210 accessible via a distributed network 201, such as the Internet, or a private network. An automated PRM 109 can similarly include a computerized PRM server 211 accessible via the distributed network 201, or via a local area network (LAN) or direct link. A subscriber or other party interested in network access 105 risk management, can use a computerized network access device 212 to receive, input, transmit or view information processed in the RMC server 210 or the PRM server 211. A protocol, such as the transmission control protocol internet protocol (TCP/IP) can be utilized to provide consistency and reliability.

A computerized network access device 204-205 can be utilized to access a network resource server 206. The network access device 204-205 can include a processor, memory and a user input device, such as a keyboard and/or mouse, and a user output device, such as a display screen and/or printer. The network access devices 204-205 can communicate with the network resource server 206 to access data and programs stored on the network resource server 206, or to run applications hosted on the network resource server 206. The network access device 204-205 may interact with the network resource server 206 as if the network resource server 206 were a single entity in the network 201. However, the network resource server 206 may include multiple processing and database sub-systems, such as cooperative or redundant processing and/or database servers that can be geographically dispersed throughout the network 201. Similarly, the risk management related servers 210-211 include a single entity in the network 201 or multiple processing and database sub-systems, such as cooperative or redundant processing and/or database servers that can be geographically dispersed throughout the network 201.

The RMC server 210 and the PRM server 211 include one or more databases 202-293 storing data relating to risk management. The RMC server 210 and the PRM server 211 may interact with and/or gather data from various sources. Gathered data can be received via electronic input and structured according to risk variables. It can also be utilized to calculate a risk quotient.

Typically a subscriber 102 or other user will access the RMC server 210 and the PRM server 211 using client software executed at a network access device 212. Similarly, an operator 207-208 of a network access device 204-205 can also utilize client software to access the network resource server 206. The client software may include a generic hypertext markup language (HTML) browser, such as Netscape Navigator or Microsoft Internet Explorer, (a “WEB browser”). The client software may also be a proprietary browser, and/or other host access software. In some cases, an executable program, such as a Java program, may be downloaded from a server 206, 210-211 to a network access device 204-205 212 and executed at the network access device 204-205 212, or a computer. Other implementations include proprietary software installed from a computer readable medium, such as a CD ROM. The invention may therefore be implemented in digital electronic circuitry, computer hardware, firmware, software, or in combinations of the above. Apparatus of the invention may be implemented in a computer program product tangibly embodied in a machine-readable storage device for execution by a programmable processor; and method steps of the invention may be performed by a programmable processor executing a program of instructions to perform functions of the invention by operating on input data and generating output.

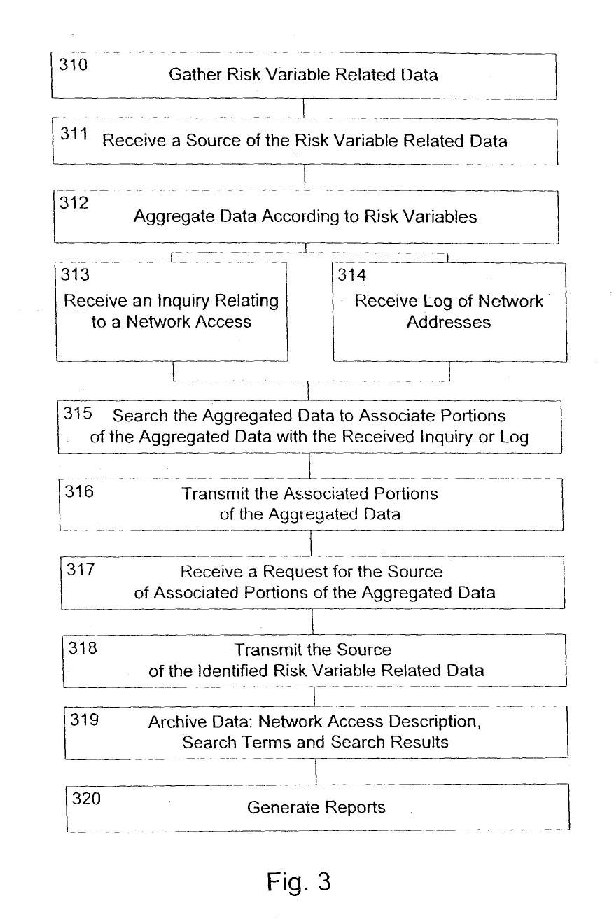

Referring now to FIG. 3, steps taken to manage risk associated with a network access 105. At 310, risk variable related data can be gathered. The risk variable related data can include data indicative of an elevated risk, such as entities or geographic locations contained on a government list such as those listed above or information related to decreased risk, such as a publicly owned corporation from a G-7 country. Informational data can be gathered from an employee of the network access 105, from a source of electronic data such as an external database, messaging system, news feed, government agency, from any other automated data provider, from a party to a transaction, or other source. Information can be received on an ongoing basis such that if new events occur in the world that relate to a specified network access 105, the information can be included in a risk calculation.

In addition to the information itself, a source of risk variable data can also be received 311 by the RMC server. For example, a source of risk variable data may include a private investigator, a government agency, an investigation firm, public records, news reports, publications issued by Treasury's Financial Crimes Enforcement Network (“FinCEN”), the State Department, the CIA, the General Accounting Office, Congress, the Financial Action Task Force (“FATF”), various international financial institutions (such as the World Bank and the International Monetary Fund), the United Nations, other government and non-government organizations, internet websites, news feeds, commercial databases, or other information sources.

A RMC server 210 or a PRM server 211 can aggregate the data received according to risk variables 312 or according to another data structure which is conducive to ascertaining risk related to network access 105.

A RMC server 210 or a PRM server 211 can be accessed in real time, or on a transaction by transaction basis. In a real time embodiment, any changes to the risk management data 107-108 may be automatically forwarded to a subscriber network access device 212 or an in-house PRM system 109. On a transaction by transaction basis, the RMC system 106 can be queried for specific data that relates to variables associated with a particular transaction.

In some embodiments, gathered data can include a recorded image or other biometric indicator of a person seeking to access a network resource. The biometric indicator can be used to memorialize an event or transaction and/or to perform a correlation between person seeking to access resource and a record of the person biometric profile. An individual's identity can be verified by digitally measuring selected features of the individual and comparing these features against the previously stored biological measurements can be utilized to ascertain an individuals identity and link the individual to other risk management data. Biometric identification can be particularly useful in the case of transactions involving foreign participants. Foreign state may not have as high a standard of knowing their customer and a correspondent bank or shell bank may have little or no knowledge to pass on. A simple biometric record can be made and transmitted along with a proposed transaction such a that a U.S. bank can perform due diligence according to the biometric records retained on suspect individuals, organizations, geographic areas, governments, or other criteria.

Such additional security measures can be linked to network access or general security and risk management.

An individual's identity can be verified and treated as a risk variable by digitally measuring selected features of the individual and comparing these features against the previously stored records of biological traits. A computer system can integrate an individual's pictures into a database, which can include an image database, text database, and transaction log etc. A digital image of an individual can be converted into face vectors, which can be stored in a transaction log database along with time, date, and identity number. Other pertinent data can also be stored if desired. Pertinent data can include, name, address, telephone number, previous history of fraud, links to known suspects or political-figures, entry on a government list, association with a known terrorist or money launderer, association with a political figure, Social Security Number, date of birth, and family relations, etc., are stored in the computer's database, usually integrated with time and attendance software.

Biometrics can also be incorporated into a system to automatically detect human presence, locate and track faces, extract face images, retina measurements or fingerprints, perform identification by matching against a database of people it has seen before or pre-enrolled images or biometrics.

To determine someone's identity in identification mode, a biometric system can compute a degree of overlap between the live image and images associated with known individuals stored in a database of facial images and biometrics. It can return a list of possible individuals ordered in diminishing relevance, or it can return an identity of a subject according to an algorithm or artificial intelligence routines and an associated risk quotient.

Other embodiments can allow a logon routine to automatically capture a facial image or other biometrics, such as a retina scan of an individual within their field of operation and perform a one-to-many match against a database of known individuals and the individuals status, including ability transact business. When a match is made, confirmation of the individual's status on the display screen and can then decide whether to take further action. Some embodiments can also include live scan systems which are used to confirm the identity of a subject as the subject transverses through an event or transaction during a network access.

Still other embodiments can include information from face recognition systems can be combined with information from other technologies. For example, biometric identification technologies can include fingerprint reading, analysis of DNA-bearing cells, retina scan or other body measurement. A risk quotient can also take into account a facial image or other biometric data.

All data received can be combined and aggregated 312 according to risk variables to create an aggregate source of data 107-108 which can be accessed to perform risk management activities. Combining data can be accomplished by any known data manipulation method. For example, the data can be maintained in separate tables and linked with relational linkages, or the data can be gathered into on comprehensive table or other data structure. In addition, if desired, information received can be associated with one or more variables including a position held by a sponsor or network access 105 partner, a country in which the fund is domiciled, how long a fund has been operating, the amount of leverage on the network access 105's assets, the veracity of previous dealings with persons associated with the network access 105, the propensity of people associated with the network access 105 to execute unlawful or unethical transactions, a type of transaction that will involve the network access 105, or other criteria.

In addition to the types and sources of risk variable data listed previously that can provide indications of high risk, received information can relate to variables such as associating a network address with: an unauthorized use of a computer resource, membership in a computer hacker organization, purchase of a text relating to gaining unauthorized access to a computer resource, geographic areas with a high incidence of suspected misuse of computer resources, access by a competitor, access by a private investigator, access by an entity related to a foreign government, or other situation that may indicate an illegitimate purpose for the access. Other risk variable data that can be received can include activities a person or entity is involved in, associates of a transactor, governmental changes, attempting to gain access to more than one resource in the same time proximity, or other related events.

At 313, the RMC server 210 or PRM server 211 can receive an inquiry relating to a network access. The inquiry from a subscriber 102, or other authorized entity, can cause the respective servers 210-211 to search the aggregated data 107-108 and associate related portions of aggregated data 107-108 with any information supplied n the inquiry 314 that relates to a network access.

Alternatively, or in addition to an inquiry relating to a network access, a log associated with a website, or other network resource, can be received 314. The log will typically contain a list of network addresses that have accessed, or attempted to access the network resource. A list of names or other associated data correlating with the network addresses can be included in a database 107-108 inquiry.

A search of the aggregated data 107-108 can be conducted to associate portions of the aggregated data with a search criteria based upon the inquiry received or the log received 315.

The associated portions of aggregated data 107-108 can be transmitted 316 to a destination designated by the inquiry requester, such as a network access device 212 or a PRM system 211, a fax machine or a voice line.

The RMC server 210 may also receive a request for the source of any associated portions of aggregated data 107-108 transmitted 317, in which case, the RMC server 210 can transmit the source of the associated portions of aggregated data 107-108 to a designated destination 318. The source may be useful in adding credibility to the data, or to facilitate further research with a request for additional information from the source.

The RMC server 210 can also store in memory, or otherwise archive risk management related data and proceedings 319. Archived risk management related data and proceedings can be useful to quantify corporate governance and diligent efforts to address high risk situations. Accordingly, reports quantifying risk management procedures, executed due diligence, corporate governance or other matters can be generated 320.

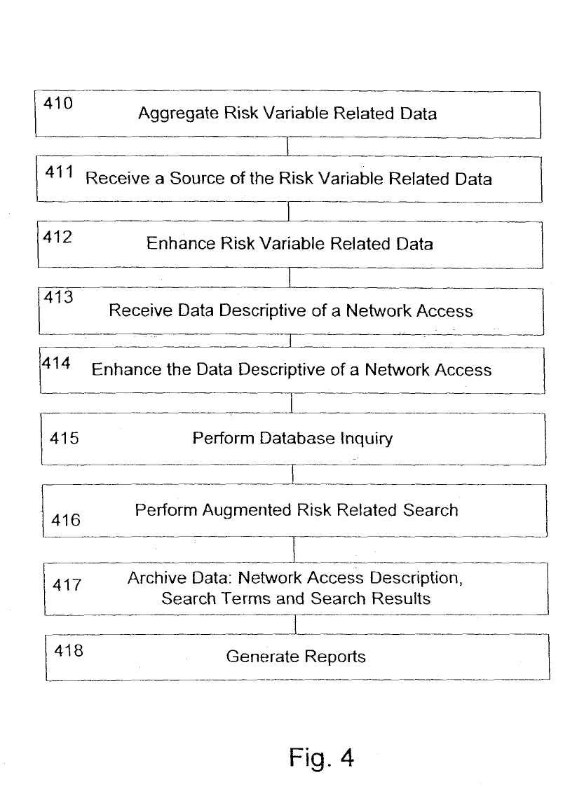

Referring now to FIG. 4, in some embodiments, the present invention can also include steps that allow an RMC server 210 or PRM server 211 to provide data augmenting functionality that allows for more accurate processing of data related to network access 105 risk management. Accordingly, at 410, a RMC server 210 or PRM server 211 can receive and aggregate risk variable related data and at 411 the source of the risk variable related data. At 412, the RMC server 210 or PRM server 211 can also enhance risk variable related data, such as, for example, through data scrubbing techniques or indexing as discussed above. At 423, data descriptive of a network access 105 can be received and in some embodiments, at 414, the data can also be scrubbed or otherwise enhanced.

A database inquiry can be performed referencing the aggregated and enhanced data 415. In addition, an augmented search that incorporates data mining techniques 416 can also be included to further expand the depth of knowledge retrieved by the inquiry. If desired, a new inquiry can be formed as a result of the augmented search. This process can continue until the inquiry and augmentation ceases to add any. additional meaningful value.

As discussed above, any searching and augmentation can be archived 417 and reports generated to quantify the due diligence efforts 418.

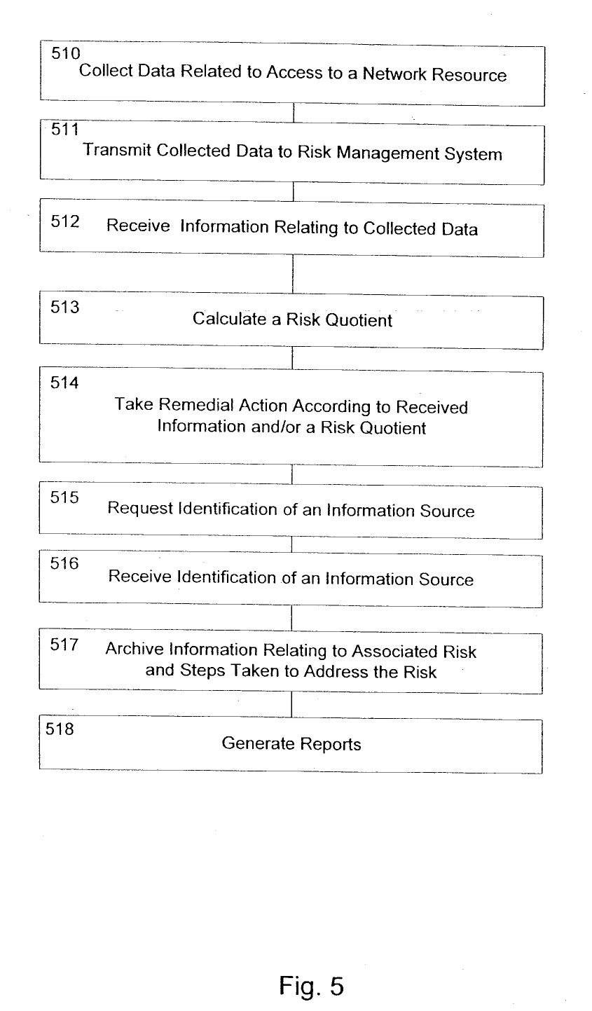

Referring now to FIG. 5, a flow chart illustrates steps that a user, such as a financial institution, can implement to manage risk associated with a network access 105. At 510, a user can collect information related to an access to a network resource, such as, for example, a network address accessing the network resource. The collected information may be received, or otherwise collected, during the normal course of business, such as during normal monitoring of an Internet website. At 511, the user can access a risk management server 210-211 and transmit to the risk management server 210-211 the collected data.

Access to a risk management server 210-211 can be accomplished, for example by opening a dialogue with an RMC system 210 or a PRM system 211 with a network access device 212. Typically, a dialogue is opened by presenting a GUI to the network access device 212 or via an electronic feed that maintains an exchange of information with a risk management server 210-211. The GUI can be capable of accepting data input via a network access device. An example of a GUI would include a series of questions relating to a network access 105. Information transmitted via the direct feed can forgo the GUI and be processed directly from a network resource server into fields of a database 107-108 maintained by a risk management server 210-211.

In some embodiments, automated monitoring software can run in the background of a normal resource sharing program and screen data traversing the shared resource. The screened data can be processed to determine key words wherein the key words can in turn be presented to a risk server 210-211 as risk subjects or risk variables. The risk server 210-211 will process the key words to identify addresses, entities or other risk variables which can be made part of a risk inquiry. Monitoring software can also be installed to screen data traversing a network or communications link.

At 512, the user can receive information from the risk management system 210-211 relating to risk associated with the collected data 512. The information can include: a name associated with a network address; any risk related lists that the name is placed on, such as those discussed above; an organization with whom the name may be associated; a sovereign nation associated with the name; a geographic area associated with the name or address; publications including the name; government filings associated with the name; court records; other government records; or other information. The information can also include enhanced data, such as scrubbed data. In some embodiments, a user can receive ongoing monitoring of key words, identified entities, a geographic location, or other subject, or list of subjects. Any updated information or change of status detected via an ongoing monitoring can result in an alarm or other alert being sent to one or more appropriate subscribers or other users.

At 513, in some embodiments, the user can also calculate a risk quotient or other risk rating based upon the risk related information received. A risk quotient or other risk rating can be calculated as a result of the analysis of the received information which relates to risk variables. For example, a numerical value or other scaled weighting can be associated with particular information linked to a variable, wherein the scaled weighting is representative of an amount of risk associated with information being linked with that variable. In addition the scaled weighting can be adjusted higher or lower, or otherwise re-weighted, depending upon information received that relates to another risk variable if the risk variables can have an effect upon each other. In this manner complex associations and can be developed between variables, and algorithms can be developed that reflect those associations.

For example, it may be determined that a registrant name associated with an TCP/IP address is a U.S. domiciled corporation and this information is correlated with a low scaled weighting, or even a negative scaled weighting. However, if other information related to a specific individual within the corporation that is also associated with the TCP/IP address has previously been convicted under the Economic Espionage Act or similar statute, the risk associated with the network resource access may be increased. The scaled weighting for the U.S corporation may also be increased if the U.S. corporation is a staunch competitor of the host of the network resource.

If desired, an additional level of weighting can be assigned to a category of variables. For example, one category of variables may include background or situational information and another a specific history of access to a specific network resource. A particular situation or transaction may place a much higher emphasis on security risk associated with a particular network resource. For example, a resource that contains highly sensitive or proprietary data may receive a higher emphasis on security. Therefore a category for the variables relating to that resource can be assigned a higher rating. In some embodiments, logic embodied in computer code can dynamically adjust both category and scaled variable weightings responsive to information received.

All weightings can also be aggregated into a risk quotient or risk subject rating score that is indicative of an amount of risk associated with a scored subject, such as access to a particular network resource by a particular network address.

Relationship algorithms can also be utilized which allow logic to determine which variables will effect other variables as well as how data entered for one variable will effect a weighting and value for another variable, such as whether data for one variable will increase risk or decrease risk associated with another variable. A relationship algorithm can also include logic to determine the extent to which a value for one variable will effect risk when combined with a value for another variable.

At 514, some embodiments, can also include a subscriber taking remedial action based upon a risk quotient and/or any information received relating to risk management 514. Remedial action can include, for example, modifying access rights to a network resource for a specific network address or notifying a appropriate authority.

At 515, some embodiments can include a subscriber requesting an identification of an information source 515. The information source can be useful to ascertain how credible a particular piece of information may be, or be utilized to contact a source to obtain additional information. For example, a source may be a government agency which may have very credible information and be able to update a concerned institution relating to a particular entity or entry on a government list. A source could also be a private investigation firm that may be available to research further information.

Receipt of the identification of an information source 516 can be accomplished via an electronic message, an entry in an electronic report, facsimile, voice message or any other available method of communication.

A user can also cause an archive to be created relating to network access related risk management 517. An archive may include, for example, information received relating to risk associated with a network access 105, inquiries made concerning the network access 105 and any results received relating to an inquiry. In addition, the user can cause an RMC server 210 or PRM server 211 to generate reports to quantify the archived information and otherwise document diligent actions taken relating to risk management 518.

A number of embodiments of the present invention have been described. Nevertheless, it will be understood that various modifications may be made without departing from the spirit and scope of the invention. For example, an entity seeking to make access to a network resource can voluntarily provide information to a resource provider or a risk management clearinghouse in order to establish credentials that can be passed along to any subscriber or resource provider. In addition, an investigation firm, auditing firm or other information provider can also voluntarily provide information to a risk management clearinghouse which can bolster the image of the information provider and also aid a subscriber. Accordingly, other embodiments are within the scope of the following claims.

What is claimed is:

1. A computer-implemented method for managing risk associated with a resource accessible via a communication network, the method comprising:
gathering data from multiple sources, wherein the data gathered comprises risk variables associated with an entity;
receiving an inquiry relating to a network address involved in accessing the resource accessible via the communication network;
associating a portion of the gathered data with the network address; and transmitting the portion of the gathered data associated with the network address to the subscriber.

2. The method of claim 1 wherein the gathered data is gathered exclusively from publicly available sources.

3. The method of claim 1 wherein the transmitted portion of gathered data comprises a name of an entity associated with the network address.

4. The method of claim 1 wherein the transmitted portions of gathered data comprises a geographic location associated with the network address.

5. The method of claim 3 or 4 wherein the transmitted portions of gathered data comprises association of the name with a government list comprising high risk variables.

6. The method of claim 5 wherein the high risk variable comprises the name of a terrorist related entity.

7. The method of claim 5 wherein the high risk variable comprises a political association.

8. The method of claim 5 wherein the high risk variable comprises the name of an entity associated with fraud.

9. The method of claim 1 additionally comprising the step of recording a pattern of access associated with an unauthorized use of the resource available on the network.

10. The method of claim 9 wherein the gathered data comprises a pattern of access by a particular network address to the resource available via the communications network.

11. The method of claim 9 wherein the gathered data comprises a pattern of access to the resource available via the communications network by multiple network addresses associated with a particular name.

12. The method of claim 1 wherein transmitting the associated portions of the aggregated data is conditioned upon receipt of a contractual obligation to limit use of the aggregated data for complying with regulatory and legal obligations associated with at least one of: (i) the detection and prevention of money laundering, (ii) fraud, (iii) corrupt practices, (iv) organized crime, and (v) activities subject to government sanctions or embargoes.

13. The method of claim 1 wherein transmitting the associated portions of the aggregated data is conditioned upon receipt of a contractual obligation to limit use of the aggregated data for at least one of: (i) the prevention or detection of a crime, (ii) the apprehension or prosecution of offenders, and (iii) the assessment or collection of a tax or duty.

14. The method of claim 1 additionally comprising the step of enhancing the gathered data.

15. The method of claim 1 wherein the gathered data related to a network address accurately reports on or consists of a governmental record.

16. The method of claim 1 additionally comprising the step of insuring that the source of gathered data gathered data related to a network address is reputable.

17. The method of claim 1 wherein the inquiry relating to a network address comprises an alert list.

18. The method of claim 17 additionally comprising the steps of continually monitoring the gathered data and transmitting any new information related the network.

19. A computer-implemented method for managing risk related to a resource accessible via a communications network, the method comprising: recording a network address of a communication device accessing the resource; transmitting the network address to a risk management clearinghouse; and receiving data related to risk variables associated with the network address.

20. The method of claim 19 additionally comprising the step of enhancing the gathered data.

21. The method of claim 20 wherein enhancing the data comprises scrubbing the data to incorporate changes in the spelling of datum.

22. The method of claim 20 or 21 wherein enhancing the data comprises utilization of an index file.

23. The method of claim 19 additionally comprising the step of calculating a risk quotient.

24. The method of claim 19 performing a remedial action according to the risk quotient.

25. The method of claim 19 additionally comprising the step of augmenting the data via data mining.

26. The method of claim 19 wherein associating portions of aggregated data comprises Boolean logic.

27. The method of claim 19 wherein associating portions of aggregated data comprises relevance ranking.

28. The method of claim 19 additionally comprising the steps of receiving a source of gathered data and transmitting the source of the associated portions of aggregated data.

29. A computerized system for managing risk associated with a resource accessible via a communication network, the system comprising:
a computer server accessible with a system access device via a communications network; and
executable software stored on the server and executable on demand, the software operative with the server to cause the system to:
gather data from multiple sources, wherein the data gathered comprises risk variables associated with an entity;
receive an inquiry relating to a network address involved in accessing the resource accessible via the communication network;
associate a portion of the gathered data with the network address;
and transmit the portion of the gathered data associated with the network address to the subscriber.

30. The computerized system of claim 29 wherein the data is gathered via an electronic feed.

31. Computer executable program code residing on a computer-readable medium, the program code comprising instructions for causing the computer to:
gather data from multiple sources, wherein the data gathered comprises risk variables associated with an entity;
receive an inquiry relating to a network address involved in accessing the resource accessible via the communication network;
associate a portion of the gathered data with the network address; and
transmit the portion of the gathered data associated with the network address to the subscriber.

32. A computer data signal embodied in a digital data stream comprising data relating to risk management, wherein the computer data signal is generated by a method comprising the steps of:
gathering data from multiple sources, wherein the data gathered comprises risk variables associated with an entity;
receiving an inquiry relating to a network address involved in accessing the resource accessible via the communication network;
associating a portion of the gathered data with the network address; and
transmitting the portion of the gathered data associated with the network address to the subscriber.

33. A method of interacting with a network access device so as to manage risk relating to a risk subject, the method comprising the steps of:
initiating interaction with a risk management server via a communications network;
inputting information descriptive of a network access;
transmitting the information descriptive of a network access to a risk management server; and
receiving data associated with risk variables that relate to the network access.

34. The method of claim 33 wherein the data received comprises data resultant to data mining.
